(19) United States
(12) Patent Application Publication
(10) Pub. No.: US 2010/0018909 A1
(43) Pub. Date: Jan. 28, 2010

(54) VIBRATING SCREEN

(76) Inventor: Jeffrey D. Smith, Manhattan, KS (US)

Correspondence Address: MICHAEL BEST & FRIEDRICH LLP, 100 E WISCONSIN AVENUE, Suite 3300, MILWAUKEE, WI, 53202, US

(21) Appl. No.: 12/504,963

(22) Filed: Jul. 17, 2009

Related U.S. Application Data
(60) Provisional application No. 61/122,274, filed on Dec. 12, 2008.
(60) Provisional application No. 61/082,738, filed on Jul. 22, 2008.

(51) Int. Cl. B07B 1/28

(52) U.S. Cl. 209/269

(57) ABSTRACT

A vibrating screen includes a frame, a screen supported by the frame, a vibration device coupled to the frame to vibrate the screen, a pressurized fluid spray assembly operable to discharge a pressurized fluid against the screen, a canopy coupled to the frame and movable between a closed position, in which at least a top side of the screen is covered by the canopy, and an open position, in which at least a portion of the top side of the screen is uncovered, an actuator coupled between the frame and the canopy to move the canopy between the closed and open positions, and a controller operably coupled to the actuator and the pressurized fluid spray assembly. The controller is operable to close the canopy and initiate operation of the pressurized fluid spray assembly in an automated sequence.

### RELATED APPLICATIONS

This application claims priority to co-pending U.S. Provisional Patent Application Serial No. 61/122,274 filed on Dec. 12, 2008 and 61/082,738 filed on Jul. 22, 2008, the entire contents of all of which are incorporated herein by reference.

### FIELD OF THE INVENTION

The present invention relates to filtration devices, and more particularly to vibrating screens.

### BACKGROUND OF THE INVENTION

Screens are often employed to de-water or reduce the amount of water or other liquids in a slurry. As the slurry moves along the screen, liquids in the slurry separate from the solids in the slurry and pass through the screen, thereby increasing the solids content of the slurry as it moves along the screen.

### SUMMARY OF THE INVENTION

The present invention provides, in one aspect, a vibrating screen including a frame, a screen supported by the frame, a vibration device coupled to the frame to vibrate the screen, a pressurized fluid spray assembly operable to discharge a pressurized fluid against the screen, a canopy coupled to the frame and movable between a closed position, in which at least a top side of the screen is covered by the canopy, and an open position, in which at least a portion of the top side of the screen is uncovered, an actuator coupled between the frame and the canopy to move the canopy between the closed and open positions, and a controller operably coupled to the actuator and the pressurized fluid spray assembly. The controller is operable to close the canopy and initiate operation of the pressurized fluid spray assembly in an automated sequence.

Other features and aspects of the invention will become apparent by consideration of the following detailed description and accompanying drawings.

### BRIEF DESCRIPTION OF THE DRAWINGS

FIG. 1 is a front perspective view of a vibrating screen of the present invention, illustrating a canopy of the vibrating screen in an open position.

FIG. 2 is a rear perspective view of the vibrating screen of FIG. 1, illustrating the canopy in a closed position.

FIG. 3 is a perspective view of a portion of a screen utilized in the vibrating screen of FIG. 1.

FIG. 4 is an enlarged, front perspective view of the vibrating screen of FIG. 1, illustrating an upper portion of the screen of FIG. 3 supported on a frame of the vibrating screen.

FIG. 5 is an enlarged, front perspective view of the vibrating screen of FIG. 1, illustrating a lower portion of the screen of FIG. 3 supported on the frame of the vibrating screen.

FIG. 6 is a top perspective view of the vibrating screen of FIG. 1, with portions removed, illustrating a pressurized fluid spray assembly positioned beneath the screen of FIG. 3 for discharging fluid through the screen.

FIG. 7 is a cross-sectional view of the vibrating screen of FIG. 1 through line 7-7 in FIG. 6.

FIG. 8 is an enlarged, side view of the vibrating screen of FIG. 1, illustrating the canopy in the open position.

FIG. 9 is an enlarged, side view of the vibrating screen of FIG. 1, illustrating the canopy in the closed position.

FIG. 10a is an enlarged, outside perspective view of the vibrating screen of FIG. 1, illustrating a clamping member in a lowered position.

FIG. 10b is an enlarged, outside perspective view of the vibrating screen of FIG. 1, illustrating the clamping member in a raised position.

FIG. 11a is an enlarged, inside perspective view of the vibrating screen of FIG. 1, illustrating the clamping member in the lowered position.

FIG. 11b is an enlarged, inside perspective view of the vibrating screen of FIG. 1, illustrating the clamping member in the raised position.

FIG. 12 is an enlarged, side view of the vibrating screen of FIG. 1, illustrating an optional roller nip assembly positioned adjacent an outlet of the vibrating screen.

FIG. 13 is an enlarged, front perspective view of the vibrating screen of FIG. 1, illustrating a plurality of optional flow separation members positioned above the screen.

FIG. 14 is a schematic of a control system utilized with the vibrating screen of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

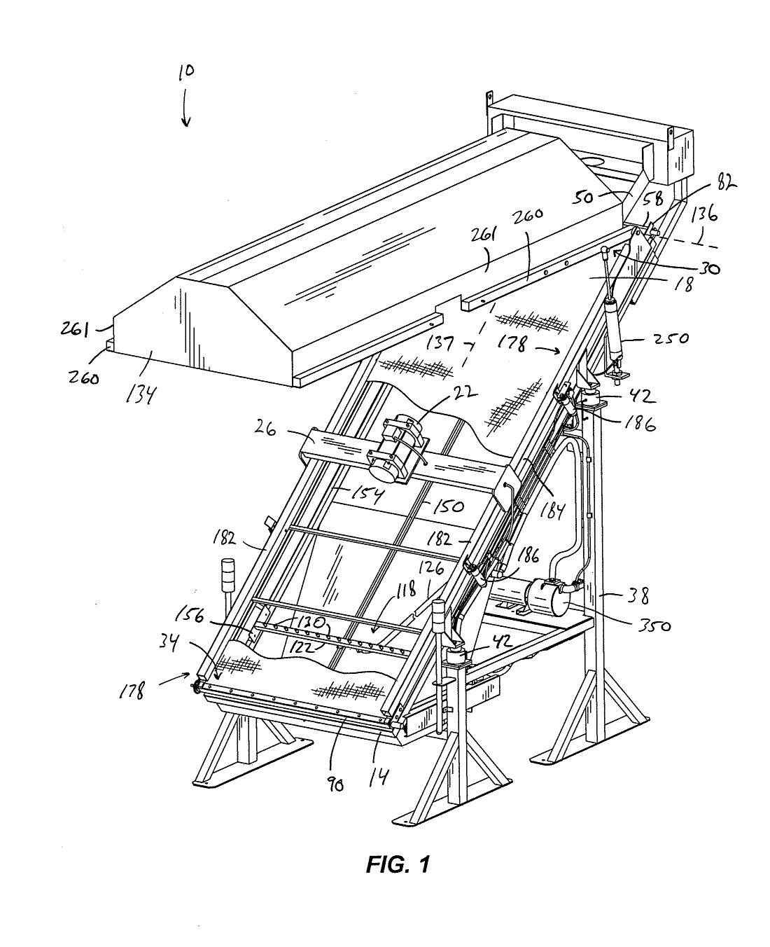

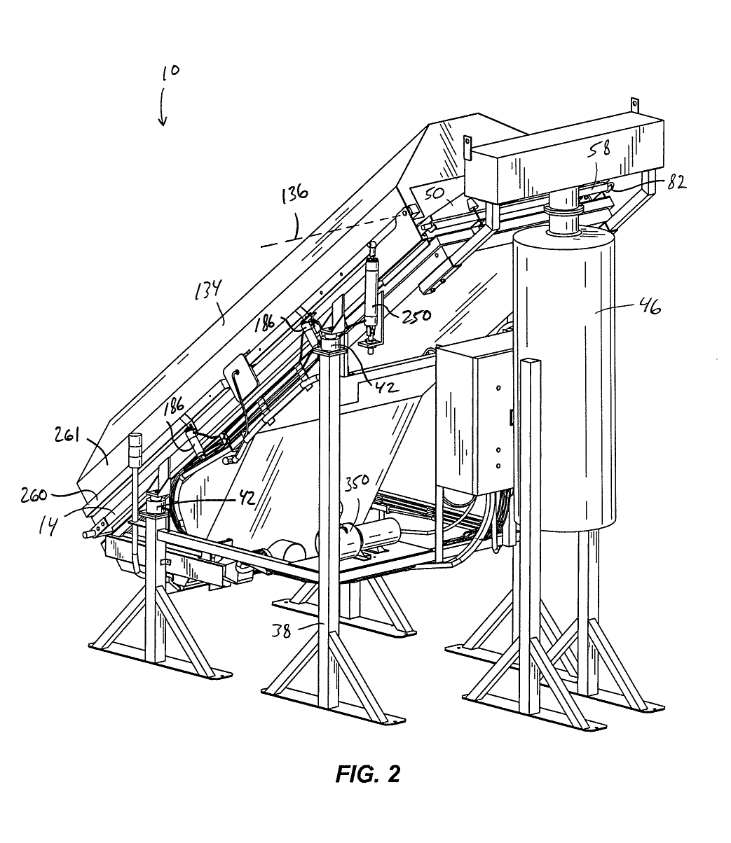

FIGS. 1 and 2 illustrate a vibrating screen 10 including a frame 14, a filter or screen 18 supported by the frame 14, and a vibration device 22 (e.g., a vibrating electric motor, a vibrating hydraulic motor, a vibrating pneumatic motor, etc.) coupled to the frame 14 to vibrate the screen 18 to move a slurry along the screen 18. In the illustrated construction of the vibrating screen 10, the vibration device 22 is coupled to the frame 14 by a support member 26 spanning the width of the screen 18 and positioned midway between respective ends 30, 34 of the screen 18. Alternatively, the vibration device 22 may be coupled to the frame 14 in any of a number of different ways and locations to vibrate the screen 18. Additional details regarding the operation of the vibrating screen 10 appear below.

With continued reference to FIGS. 1 and 2, the frame 14 and screen 18 are supported at an incline relative to the ground by a second frame or stand 38. Air mounts 42 are positioned between the frame 14 and the frame 38 to reduce the amount of vibration transferred to the stand 38 and the foundation of the stand 38. The air mounts 42 may be configured in any of a number of different ways (e.g., as inflatable bladders, etc.) to reduce or attenuate the amount of vibration transferred from the frame 14 to the stand 38 and the foundation of the stand 38. Alternatively, different components or structure may be utilized to reduce or attenuate the amount of vibration transferred to the stand 38 and the foundation of the stand 38.

With reference to FIG. 2, a tank 46 is utilized to deliver a slurry to the vibrating screen 10. A header 50 receives the slurry from the tank 46 and transfers the slurry to the vibrating screen 10 in a uniform manner across the width of the screen 18 (see also FIG. 1). The header 50 may be coupled to the tank 46 and/or the frame 14 of the vibrating screen 10 in any of a number of different ways. Although not shown in the drawings, a conveyor may be positioned adjacent the outlet of the vibrating screen 10 to receive the dewatered or de-liquefied slurry from the screen 18. As used herein, a “dewatered” or “de-liquefied” slurry refers to a slurry having an increased solids content as a result of water or other liquids being removed from the slurry while moving along the vibrating screen 10. The conveyor may include an auger or any of a number of different components configured to transport the dewatered slurry from the outlet of the vibrating screen 10.

With reference to FIG. 3, the screen 18 is made from a plastic material (e.g., nylon, polyester, etc.) with a pore size (e.g., as small as 20 microns or lower, or as large as 2,000 microns or higher) matched to a particular filtration application. The first end 30 of the screen 18 is attached to a mounting member 58. Specifically, the mounting member 58 is configured as a square tube inserted through a loop 62 formed by the screen 18. Such a loop 62 may be formed by folding the top edge of the screen 18 over an interior portion of the screen 18 and stitching the edge of the screen 18 to an interior portion of the screen 18 along one or more seams. In an alternative construction of the vibrating screen 10, the screen 18 may include a plurality of eyelets spaced along the width of the screen 18 adjacent the top edge of the screen 18, and the mounting member 58 may include a plurality of corresponding posts over which the eyelets are inserted to secure the end 30 of the screen 18 to the mounting member 58. In another alternative construction of the vibrating screen 10, the mounting member 58 may include a longitudinal slit through which the top edge of the screen is inserted, and the mounting member 58 may be rotated to wrap at least a portion of the screen 18 about the outer periphery of the mounting member 58 to frictionally secure the end 30 of the screen 18 to the mounting member 58. Alternatively, the end 30 of the screen 18 may be secured to the mounting member 58 in any of a number of different ways (e.g., using fasteners, adhesives, and so forth). The mounting member 58 may also be configured having any of the number of different cross-sectional shapes (e.g., circular, etc.) rather than the illustrated square cross-sectional shape.

With continued reference to FIG. 3, the opposite end 34 of the screen 18 includes a plurality of eyelets 66 spaced along the width of the screen 18. Alternatively, a second mounting member may be inserted through a loop formed at the end 34 of the screen 18, and the eyelets 66 may coincide with corresponding apertures in the second mounting member through which posts or fasteners (e.g., bolts) are inserted to secure the end 34 of the screen 18 to the frame 14 of the vibrating screen 10. The screen 18 may be provided to users of the vibrating screen 10 as wound or wrapped about the mounting member 58.

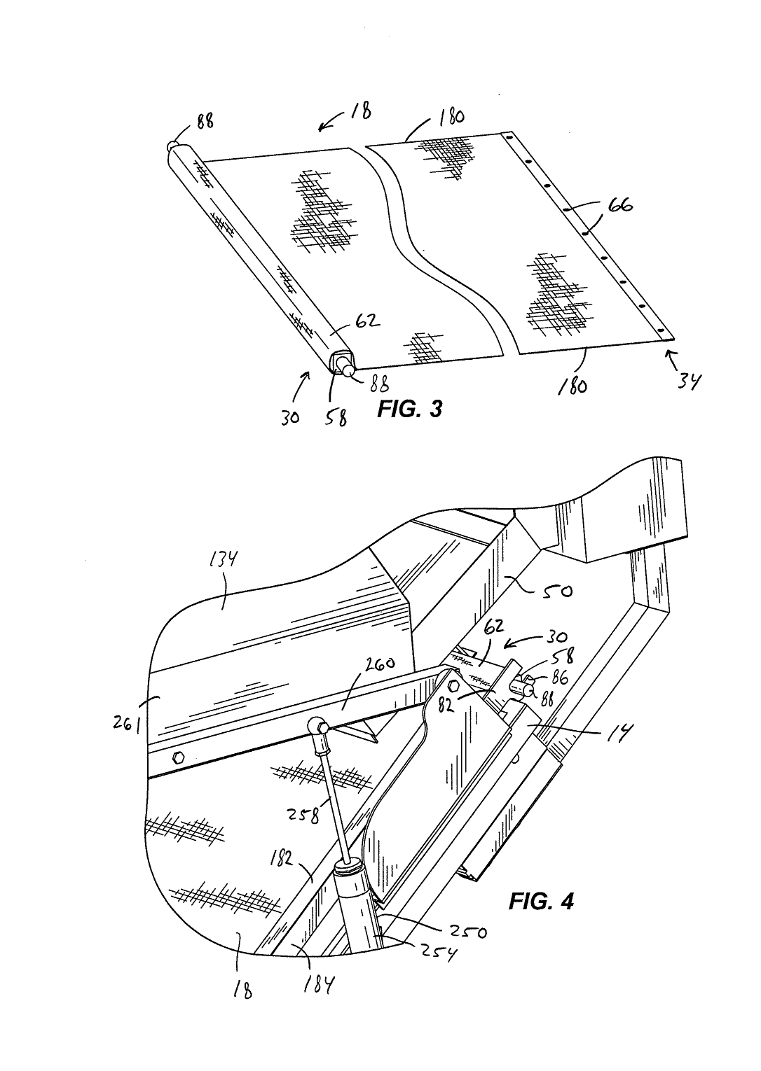

With reference to FIG. 4, the vibrating screen 10 includes a first support member 82 to which the first end 30 of the screen 18 is attached. Specifically, the first support member 82 is configured as a plate having a cutout or notch 86 into which one end of the mounting member 58 is received to support the first end 30 the screen 18. Although not shown in FIG. 4, the vibrating screen 10 includes another first support member, structurally similar to the support member 82 shown in FIG. 4, on the other side of the frame 14 to support the opposite end of the mounting member 58. The notch 86 in each of the first support members 82 is shaped to correspond with at least a portion of the outer periphery of the mounting member 58. As a result, the mounting member 58 may be received within the respective notches 86 of the first support members 82 to support the opposite ends of the mounting member 58. In the illustrated construction of the vibrating screen 10, each of the notches 86 is at least partially defined by a radius to correspond with cylindrical ends 88 of the mounting member 58. Alternatively, the notches 86 may be configured in any of a number of different ways to correspond with any of a number of different cross-sectional shapes of the mounting member 58.

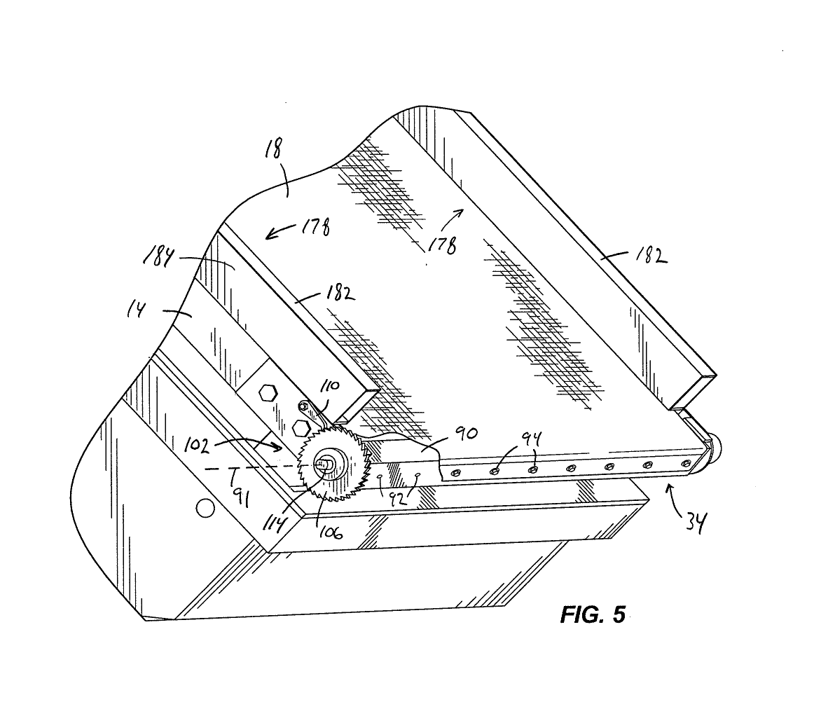

With reference to FIG. 5, the vibrating screen 10 includes a second support member 90 to which the second end 34 of the screen 18 is attached. Specifically, the second support member 90 is configured as a square tube supported for rotation about an axis 91 extending in the direction of the width of the screen 18. Any of a number of different structural arrangements (e.g., including bearings, bushings, etc.) may be utilized to rotatably support the second support member 90 on the frame 14. The second support member 90 includes a plurality of threaded apertures 92 spaced across the width of the support member 90 into which threaded fasteners (e.g., bolts 94) may be inserted. The spacing of the threaded apertures 92 across the width of the support member 90 corresponds with the spacing of the eyelets 66 in the second end 34 of the screen 18, thereby allowing the second end 34 of the screen 18 to be fastened to the second support member 90.

Alternatively, any of a number of different structural arrangements may be utilized to connect the second end 34 of the screen 18 to the second support member 90. For example, as previously described, the second support member 90 may include a plurality of upstanding posts that are inserted into the respective eyelets 66 in the screen 18. A cotter pin may be engaged to each of the posts to secure the eyelets 66 and the second end 34 of the screen 18 to the second support member 90. Quick-connect or quick-release clamps can also be utilized to interconnect the second end 34 of the screen 18 and the second support member 90, in addition to or in place of the combination of the eyelets 66 and the posts. As previously described, the second end 34 of the screen 18 may be configured with the second mounting member (e.g., a dowel rod or a flat bar) to reinforce the connection between the second end 34 of the screen 18 and the support member 90.

With reference to FIG. 5, the vibrating screen 10 includes a locking mechanism 102 to facilitate stretching or tightening the screen 18 over the frame 14. The locking mechanism 102 includes a ratchet wheel 106 coupled to one end of the second support member 90, and a pawl 110 pivotably coupled to the frame 14. The ratchet wheel 106 and pawl 110 are configured to allow rotation of the second mounting member 90 about its axis 91 in a clockwise direction, while preventing rotation of the second mounting member 90 about its axis 91 in a counterclockwise direction. This arrangement allows the second support member 90 to be incrementally rotated about its axis 91 in a clockwise direction, after the mounting member 58 is received within the notches 86 of the first support members 82 and the second end 34 of the screen 18 is attached to the second support member 90, to stretch or tighten the screen 18 over the frame 14. The second support member 90 also includes a protrusion 114 having an outer peripheral surface onto which a conventional hand tool (e.g., a wrench) may grasp to allow a user to rotate the second support member 90 and incrementally tighten the screen 18 over the frame 14. Alternatively, a handle or crank may be coupled to the second support member 90 to facilitate tightening of the screen 18 over the frame 14. As a further alternative, any of a number of different structural arrangements and components may be utilized in place of the ratchet wheel 106, pawl 110, and protrusion 114 of the illustrated locking mechanism 102.

It should be understood that the location of the first and second support members 82, 90 may be switched, such that the screen 18 is stretched and tightened from the top of the frame 14 rather than the bottom of the frame 14, as shown in the drawings. The combination of the first and second support members 82, 90, and the mounting member 58 and the eyelets 66 in the second end 34 of the screen 18 facilitate quick interchangeability of the screen 18 by the user of the vibrating screen 10. In addition, this structure reduces the amount of downtime in replacing the screen 18 compared to the downtime associated with removing and replacing screens in conventional vibrating screens.

With reference to FIGS. 1 and 5, the vibrating screen 10 also includes dual clamping members 178 oriented in a direction parallel to the length of the screen 18 and disposed adjacent respective longitudinal edges 180 of the screen 18 (see FIG. 3) to selectively clamp the longitudinal edges 180 of the screen 18 against the frame 14. In the illustrated construction of the vibrating screen 10 as shown in FIGS. 1 and 5, each clamping member 178 is configured as a rail 182 having a flat lower surface engageable with a corresponding flat upper surface of a longitudinal frame rail of the frame 14. Alternatively, the lower surface of the rails 182 may include features (e.g., knurls, serrations, etc.) to increase the surface area of the rails with which to grip or engage the screen 18. Further, in the illustrated construction of the vibrating screen 10, each of the rails 182 has a length substantially similar to that of the screen 18 to substantially seal the screen 18 against the frame 14 and to create a boundary wall along each longitudinal edge of the screen 18 to substantially prevent slurry from spilling over the surface of the screen 18. Each of the rails 182 is made from a corrosion-resistant material (e.g., fiberglass, stainless steel, etc.) Alternatively, other structures may be employed to facilitate sealing the screen 18 against the frame 14. In addition, the frame 14 includes respective outer walls 184 on each side of the frame 14 against which the rails 182 are positioned. The outer walls 184 also create a boundary along the longitudinal sides of the frame 14 to substantially prevent slurry from spilling over the longitudinal sides of the frame 14.

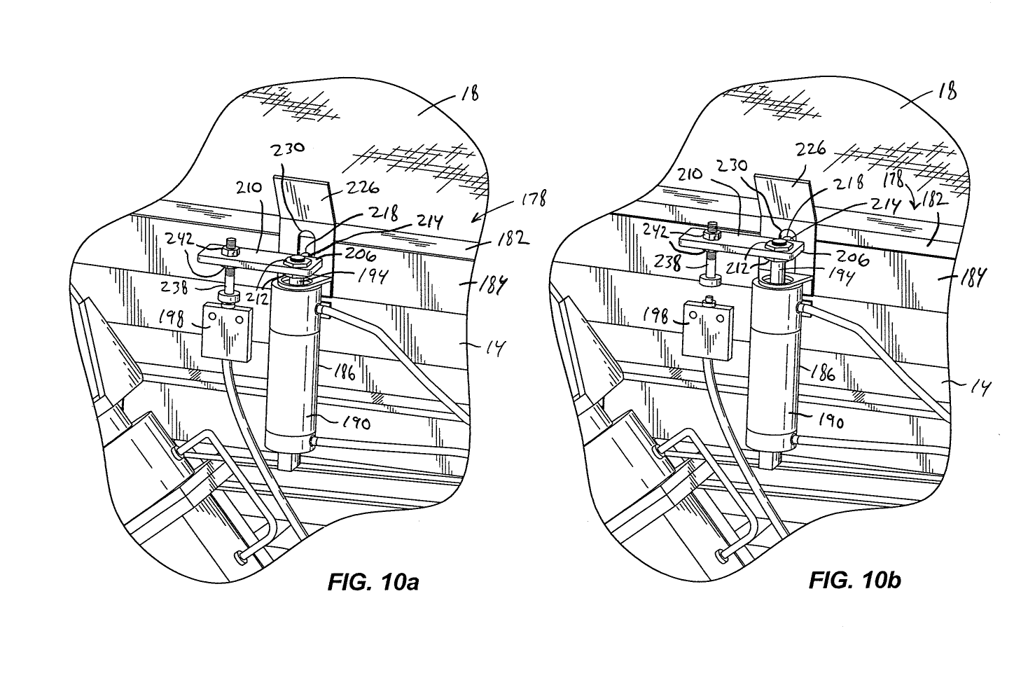

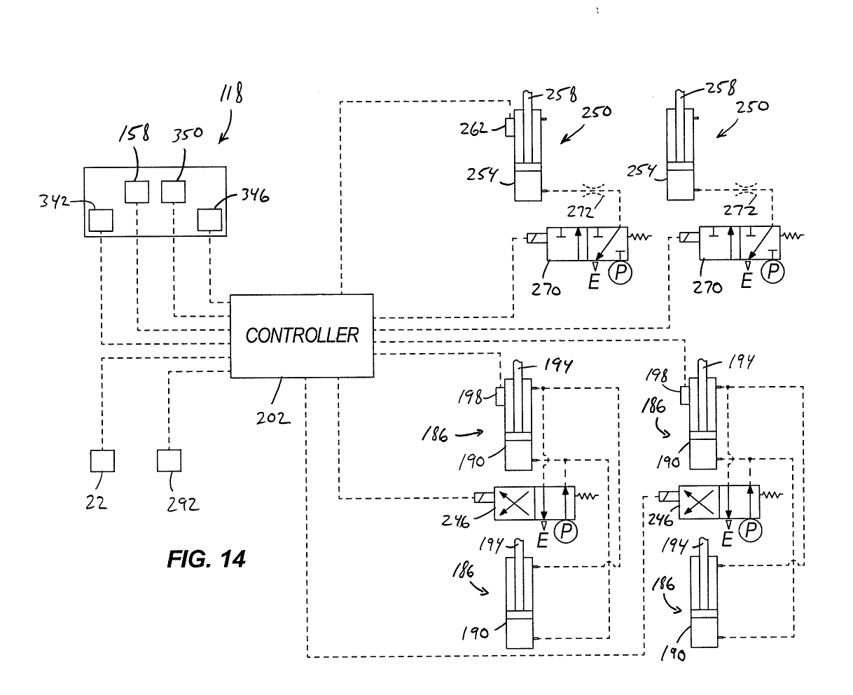

With continued reference to FIG. 1, one or more cylinders 186 may be utilized to provide a clamping force on each rail 182 against the frame 14 and to lift or raise each of the rails 182 off of the frame 14 to allow the screen 18 to be changed. In the illustrated construction of the vibrating screen 10, two cylinders 186 are utilized for each of the rails 182 to provide a distributed clamping force on each rail 182. Alternatively, only a single cylinder 186 may be utilized in combination with a pivot to selectively raise and lower each of the rails 182. As a further alternative, more than two cylinders 186 may be utilized to raise and lower each of the rails 182 to provide a more uniform distribution of clamping force along the length of each of the rails 182. With reference to FIGS. 10a and 10b, each cylinder 186 includes a housing 190 mounted to the frame 14 and an extensible rod 194 mounted to a respective rail 182. Alternatively, the housing 190 may be mounted to the rail 182 and the rod 194 may be mounted to the frame 14. The vibrating screen 10 includes a limit switch 198 associated with one of the cylinders 186 on each side of the screen 10 in electrical communication with a controller 202 (see FIG. 14; described in more detail below) to provide a signal to the controller 202 when the extensible rods 194 of the cylinders 186 are fully retracted. Alternatively, other communication means may be employed between the cylinders 186 and the controller 202 to signal the controller 202 the position of the extensible rods 194 relative to the respective cylinder housings 190, and therefore the position of the rails 182 relative to the frame 14. As a further alternative, the clamping members 178 may be manually actuated (e.g., using a handle-operated threaded screw) rather than being actuated by the cylinders 186 and the controller 202.

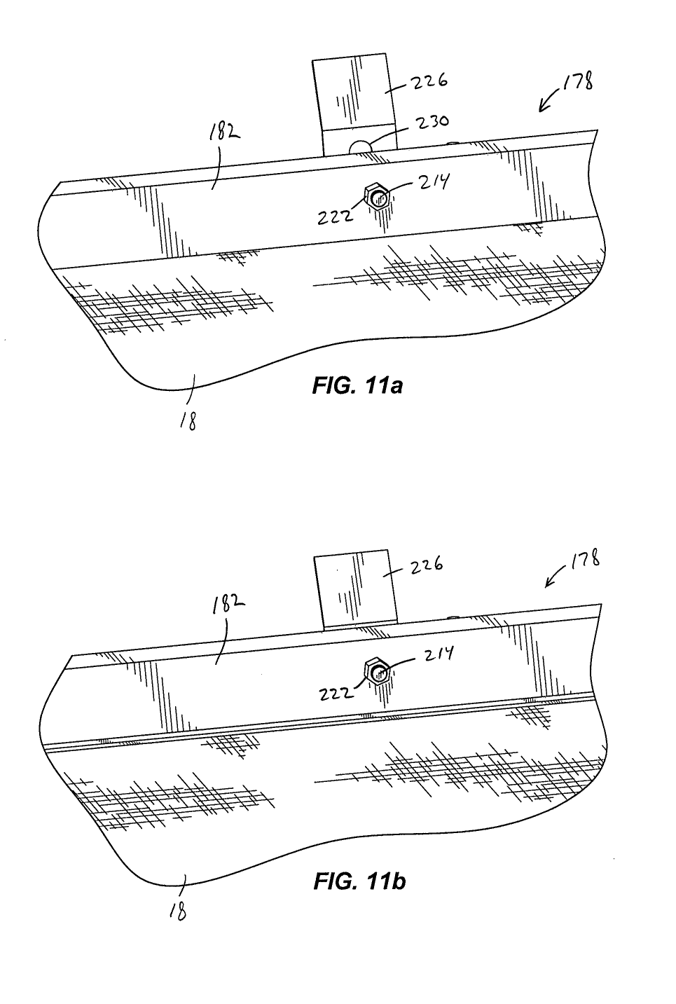

With reference to FIGS. 10a and 10b, a threaded coupling 206 is utilized to interconnect the rod 194 of each of the cylinders 186 with the rail 182. Particularly, the coupling 206 includes a substantially flat portion 210 including an aperture through which the rod 194 is insertable. The flat portion 210 of the coupling 206 is clamped between respective nuts 212 threaded to the extensible rod 194. Further, the coupling 206 includes a threaded shank 214 (see FIGS. 11a and 11b) extending from the substantially flat portion 210 in a direction substantially normal to the axis of the extensible rod 194. The threaded shank 214 is inserted through a corresponding threaded aperture in the rail 182. Another fastener (e.g., a nut 222) is threaded to the end of the threaded shank 214 to secure the coupling 206 to the rail 182.

With reference to FIGS. 10a and 10b, a guide bracket 226 is provided for each of the cylinders 186 to guide the movement of the rail 182 as the extensible rod 194 of each cylinder 186 extends and retracts. Particularly, the guide brackets 226 are coupled to the respective outer walls 184 of the frame 14 inline with the outer walls 184 (e.g., by welding, integrally forming, etc.), and each of the guide brackets 226 includes a slot 230 through which the threaded shank 214 extends. With reference to FIGS. 10a and 10b, the coupling 206 includes a threaded aperture in the substantially flat portion 210 and a threaded stop 238 (e.g., a bolt) received in the threaded aperture. Additional fasteners (e.g., nuts 242) are threaded to the stop 238 and jammed against the substantially flat portion 210 to prevent unintentional rotation of the stop 238. The purpose of the stop 238 is discussed below. Alternatively, different structure may be employed to guide the movement of each of the rails 182 relative to the frame 14 as the cylinders 186 extend and retract to raise and lower the rails 182.

To actuate the cylinders 186 to raise and lower the rails 182 with respect to the outer walls 184 of the frame 14, the controller 202 (e.g., a touch screen PLC) may be interfaced with one or more valves 246 (see FIG. 14) to selectively direct pressurized fluid (e.g., air, hydraulic fluid, etc.) to the cylinders 186. In the illustrated construction of the vibrating screen 10, the controller 202 is operable to actuate the valves 246 which, in turn, direct pressurized air to the cylinders 186 (i.e., below the piston in each cylinder 186) to release the clamping force exerted by the cylinders 186 and extend the rods 194 to raise the rails 182 from the frame 14, at which time the screen 18 may be removed from the frame 14 for replacement. The air in the opposite side of the cylinder 186 (i.e., the air above the piston in each cylinder 186) is exhausted to the atmosphere through the valves 246.

To lower the rails 182 after a replacement screen 18 is installed as described above, the controller 202 is operable to actuate the valves 246 to direct pressurized air to the opposite side of each of the cylinders 186 (i.e., above the piston in each cylinder 186) to cause the extensible rods 194 to retract into their respective cylinder housings 190 and apply a clamping force to the rail 182 against the frame 14. The air in the bottom side of each cylinder 186 (i.e., the air below the piston in each cylinder 186) is exhausted to the atmosphere through the valves 246. When the cylinder rods 194 are retracted to a position in which a sufficient clamping force is applied to the rails 182 and the frame 14, the limit switch 198 is triggered by the stop 238, thereby signaling the controller 202 that the rails 182 are in their lowered or clamping positions. The controller 202 may be operable to actuate the valves 246 and the cylinders 186 in the above-described manner in response to a manual input from an operator, or as part of an automated process programmed into the controller 202 (described in more detail below).

As shown in FIG. 14, each of the valves 246 is configured as a four-port, two-position, solenoid-actuated valve. Also, the valves 246 are arranged such that the biased or home position of each of the valves 246 corresponds to moving the rails 182 toward their raised positions, while the solenoid-actuated position of each of the valves 246 corresponds to moving the rails 182 toward their lowered or clamping positions. Alternatively, the biased and solenoid-actuated configurations of the valves 246 may be reversed, such that actuating the valves 246 by energizing the respective solenoids of the valves 246 causes the rails 182 to move to their raised positions, and de-energizing the respective solenoids of the valves 246 causes the rails 182 to move to their lowered or clamping positions.

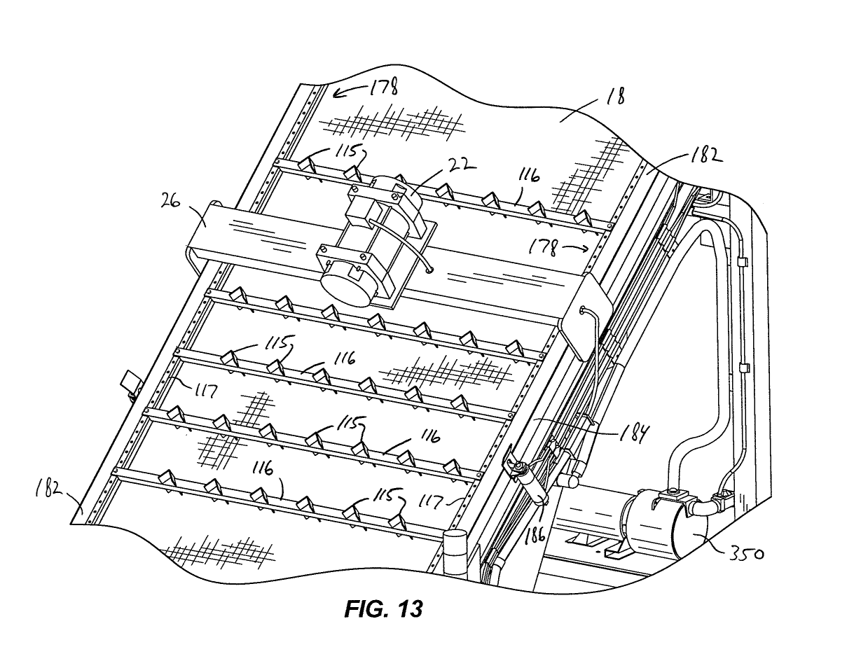

With reference to FIG. 13, the vibrating screen 10 may include a plurality of flow separation members or flow separators 115 positioned above the screen 18 to facilitate separation of clumps in the slurry as it moves along the length of the screen 18. In addition, the flow separators 115 redirect the slurry in a direction non-parallel to the length of the screen 18 to increase the distance traversed by the slurry between the respective ends 30, 34 of the screen 18. In the illustrated construction, each of the flow separators 115 is V-shaped, with the pointed end of each separator 115 facing the top end 30 of the screen 18. Alternatively, the flow separators 115 may include any of a number of different configurations or shapes. With continued reference to FIG. 13, the flow separators 115 are supported above the screen 18 by a plurality of supports 116 spanning the width of the screen 18 which, in turn, are coupled at opposite ends of each support 116 to the respective rails 182. In the illustrated construction, intermediate brackets 117 are utilized to interconnect the supports 116 and the rails 182. The intermediate brackets 117 each include a plurality of spaced apertures to allow the supports 116 and the flow separators 115 to be incrementally positioned along the length of the screen 18 (e.g., using fasteners). Alternatively, the supports 116 may be directly attached or mounted to the rails 182.

The vibrating screen 10 further includes a canopy 134 extending along and covering the length of the screen 18 (see FIGS. 1 and 2). The canopy 134 is pivotably supported on the frame 14, and the canopy 134 may be opened and closed manually or actuated automatically (e.g., using the controller 202). As shown in FIGS. 1 and 2, the canopy 134 is pivotable relative to the frame 14 about an axis 136 oriented transversely to a longitudinal axis 137 of the screen 18. Alternatively, the canopy 134 may be pivotable relative to the frame 14 about an axis oriented in a direction parallel to the longitudinal axis 137 of the screen 18. The canopy 134 may be actuated automatically utilizing one or more cylinders (e.g., cylinders 250) operably coupled to the controller 202 (see FIG. 14). Each cylinder 250 includes a housing 254 mounted to the frame 14 and an extensible rod 258 mounted to the canopy 134 (see FIGS. 1, 2, 8, and 9). Particularly, the rods 258 are mounted to respective longitudinal rails 260 secured to opposite sides of the canopy 134. Alternatively, the housing 254 may be mounted to the canopy 134 and the rod 258 may be mounted to the frame 14.

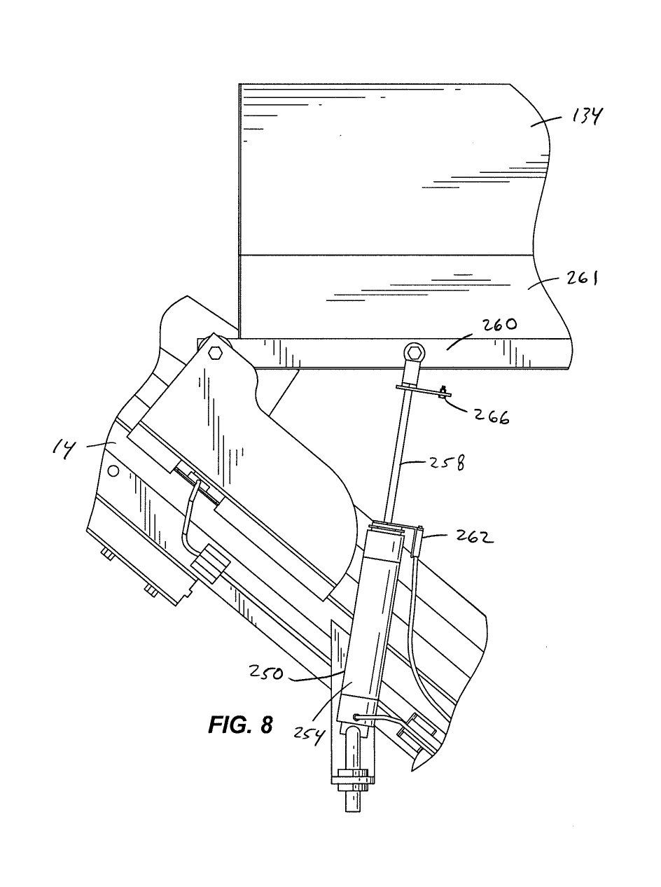

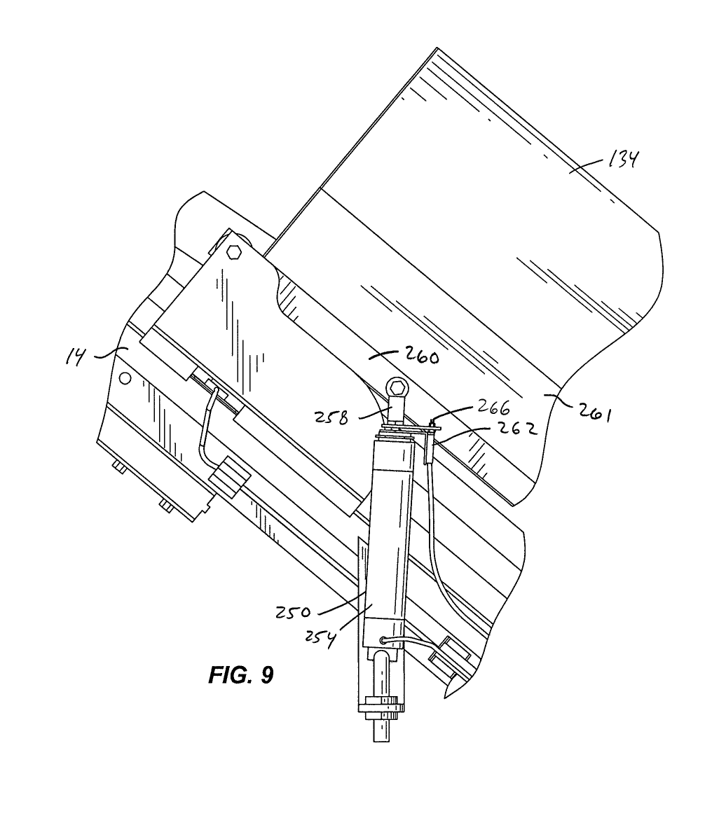

The vibrating screen 10 includes a limit switch 262 associated with one of the cylinders 250 in electrical communication with the controller 202 to provide a signal to the controller 202 when the extensible rods 258 of the cylinders 250 are fully retracted (see also FIGS. 8, 9, and 14). With reference to FIGS. 8 and 9, a stop 266 is coupled to the rod 258 in a similar manner as the flat portion 210 and stop 238 are coupled to the cylinder 186 to trip the limit switch 262. Alternatively, other communication means may be employed between the cylinder 250 and the controller 202 to signal to the controller 202 the position of the extensible rod 258 relative to the housing 254, and therefore the position of the canopy 134 relative to the frame 14.

To actuate the cylinders 250, the controller 202 may be interfaced with one or more valves 270 (see FIG. 14) to selectively direct pressurized fluid (e.g., air, hydraulic fluid, etc.) to the cylinders 250 to extend and retract the cylinder rods 258 to pivot the canopy 134 relative to the frame 14. In the illustrated construction of the vibrating screen 10, the controller 202 is operable to actuate the valves 270 which, in turn, direct pressurized air to the cylinders 250 (i.e., below the piston in each cylinder 250) to extend the rods 258 and pivot the canopy 134 to an open position. Air above the piston in each cylinder 250 is exhausted through an open port in the upper portion of each cylinder 250.

To close the canopy 134, the controller 202 is operable to actuate the valves 270 to exhaust the pressurized air in the lower portions of the respective cylinders 250 to the atmosphere through the valves 270. The weight of the canopy 134 causes the cylinder rods 258 to retract into their respective housings 254 as the canopy 134 pivots to a closed position. When the cylinder rods 258 are fully retracted, the limit switch 262 is triggered by the stop 266, thereby signaling the controller 202 that the canopy 134 is in its closed position. Each of the cylinders 250 includes an internal pressure regulator (illustrated schematically by reference numeral 272) to control the flow of pressurized air to and from the cylinders 250 while the rods 258 are extending to provide a controlled ascent of the canopy 134, and while the rods 258 are retracting to provide a controlled descent of the canopy 134. As is explained in greater detail below, the canopy 134 is opened and closed in an automated sequence with operation of the pressurized fluid spray assembly 118. The canopy 134 is lowered to its closed position prior to operation of the pressurized fluid spray assembly 118, and raised to its open position after operation of the pressurized fluid spray assembly 118 has ceased. When the canopy 134 is in its raised position, the operator of the vibrating screen 10 may visually inspect the slurry as it moves along the length of the screen 18 to ensure proper operation of the screen 10.

With reference to FIG. 14, each of the valves 270 is configured as a three-port, two-position, solenoid-actuated valve. Also, the valves 270 are arranged such that the biased or home position of each of the valves 270 corresponds to lowering the canopy 134 to its closed position, while the solenoid-actuated position of each of the valves 270 corresponds to raising the canopy 134 toward its open position. Alternatively, the biased and solenoid-actuated configurations of the valves 270 may be reversed, such that energizing the respective solenoids of the valves 270 causes the canopy 135 to be lowered to its closed position, and de-energizing the respective solenoids of the valves 270 causes the canopy to be raised to its open position.

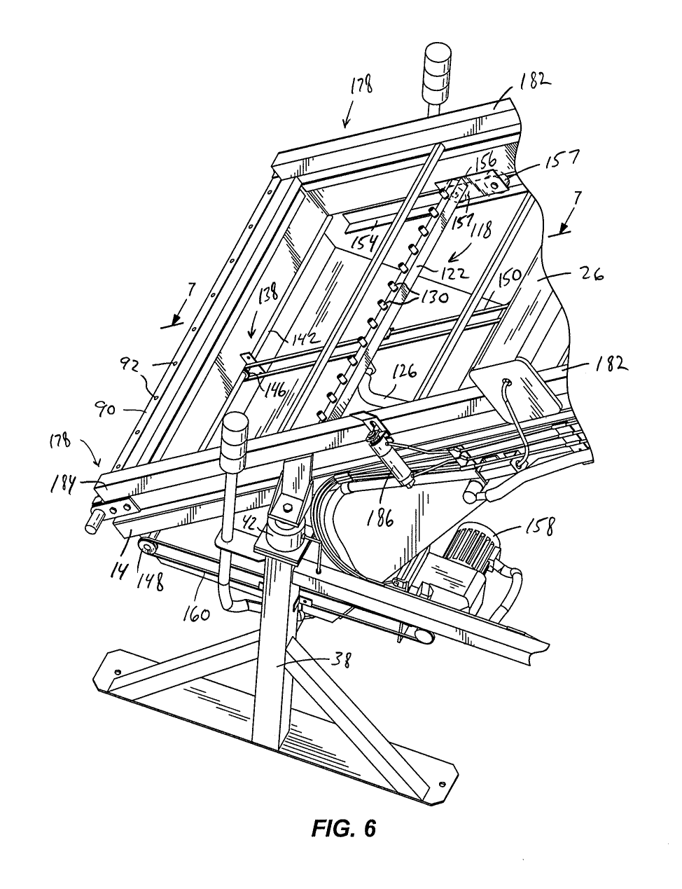

With reference to FIGS. 1 and 6, the vibrating screen 10 also includes a pressurized fluid spray assembly 118 operable to discharge a pressurized fluid against the underside of the screen 18 (i.e., the side opposite the slurry-carrying side of the screen 18). The pressurized fluid spray assembly 118 includes a conduit 122 into which pressurized fluid is delivered by a hose 126, and a plurality of nozzles 130 coupled to the conduit 122 and in fluid communication with the interior of the conduit 122 to receive pressurized fluid from the conduit 122. Any of a number of different devices (e.g., pumps) may be utilized to provide the pressurized fluid to the conduit 122.

With reference to FIG. 6, the conduit 122 is moveable relative to the frame 14, along the length of the frame 14, to spray pressurized fluid against the underside the screen 18. The pressurized fluid spray assembly 118 is movable along the length of the screen 18 by a drive system 138, which includes spaced, parallel shafts 142 (only the lower of which is shown) that are rotatably supported by the frame 14. Each of the shafts 142 includes a pulley 146 positioned near the middle of each of the shafts 142. A first endless drive member 150 (e.g., a belt, cable, etc.) is wrapped around the pulleys 146 of the respective shafts 142 to transfer rotation from the drive shaft (i.e., the lower shaft 142) to the driven shaft (i.e., the upper shaft 142). The conduit 122 is attached to the endless drive member 150 and moves with the endless drive member 150 as it is rotated by the pulleys 146.

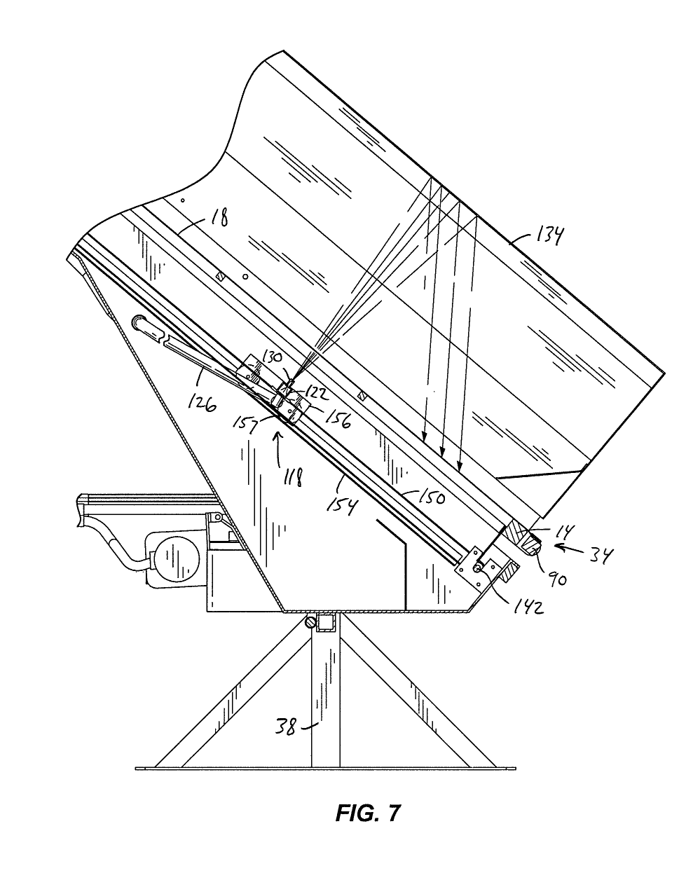

The vibrating screen 10 also includes spaced, parallel tracks 154 coupled to the frame 14 and oriented along the length of the frame 14, between which the conduit 122 is positioned (see also FIG. 7). Respective guides 156 (e.g., plates) are coupled to each end of the conduit 122 to seal the conduit ends, and a plurality of rollers 157 are supported by the guides 156 to facilitate rolling the conduit 122 along the tracks 154. Alternatively, the rollers 157 may be omitted, and the guides 156 may include other structure configured to facilitate sliding movement of the conduit 122 relative to the tracks 154. For an embodiment of the pressurized fluid spray assembly 118 including sliding guides 156, the tracks 154 may be made from a plastic material (e.g., an ultra-high molecular weight polymer) or a similar material having a low coefficient of friction to facilitate sliding of the conduit 122 along the length of the frame 14. As a further alternative, the parallel tracks 154 and rollers 157 may be positioned further inboard relative to the frame 14 compared to the position of the tracks and rollers 157 shown in FIG. 6. For example, the tracks 154 and rollers 157 may be positioned adjacent or proximate the endless drive member 150. In this configuration of the vibrating screen 10, the tracks 154 may alternatively be omitted, and the rollers 157 may engage a drain pan or other structure disposed beneath the conduit 122. The vibrating screen 10 further includes a motor 158 coupled to the lower shaft 142 via a pulley 148 and a second endless drive member 160 to rotate the shafts 142 via the drive system 138 (see FIG. 6). Alternatively, a worm drive mechanism may be utilized in place of drive system 138 to move the pressurized fluid spray assembly 118 along the length of the frame 14 and the screen 18. As a further alternative, the pulleys 146, 148 may be configured as sprockets, and the endless drive members 150, 160 may be configured as chains for rotating the shafts 142.

The motor 158 is configured as a reversing motor, and moves the conduit 122 along the length of the screen 18 in a reciprocating manner when the pressurized fluid spray assembly 118 is in operation. Upper and lower limit switches 342, 346 (see FIG. 14) interface with the controller 202 and signal the controller 202 to reverse the direction of the motor 158 upon contact with the conduit 122, guides 156, and/or rollers 157. The motor 158 may operate to move the conduit 122 at a rate of about one-quarter of a foot per second. The controller 202 may be programmed to implement a delay (e.g., one second) between reversing directions of the motor 158 and the conduit 122. The controller may also interface with a pump 350 for generating the pressurized fluid for discharge through the conduit 122 (see FIGS. 1 and 14).

In operation of the vibrating screen 10, the pressurized fluid spray assembly 118 may be manually operated by the user of the vibrating screen 10 (e.g., by a system of hand cranks, etc.), or automatically operated by a control system (e.g., including the controller 202, valves 246, 270, limit switches 342, 346, the motor 158, and the pump 350 generating the pressurized fluid for discharge through the conduit 122). In addition to preventing clogging of the screen 18, the upflow of the pressurized fluid through the screen 18 facilitates separation of solid particles of different sizes in the slurry, thereby allowing particles having a smaller size than the pores of the screen 18 to pass through the screen 18 with the water or other liquids separated from the slurry.

Also, in operation of the vibrating screen 10, the canopy 134 deflects pressurized fluid that passes through the screen 18 back onto the top side of the screen 18 (see FIG. 7). The controller 202 is operable to automatically close the canopy 134 when the pressurized fluid spray assembly 118 is utilized and open the canopy 134 when operation of the pressurized fluid spray assembly 118 is stopped. The canopy 134 is made from a corrosion resistant material (e.g., an aluminum-plastic resin composite material), and may include one or more internal deflectors (not shown) operable to deflect pressurized fluid that passes through the screen 18 back onto the top side of the screen 18.

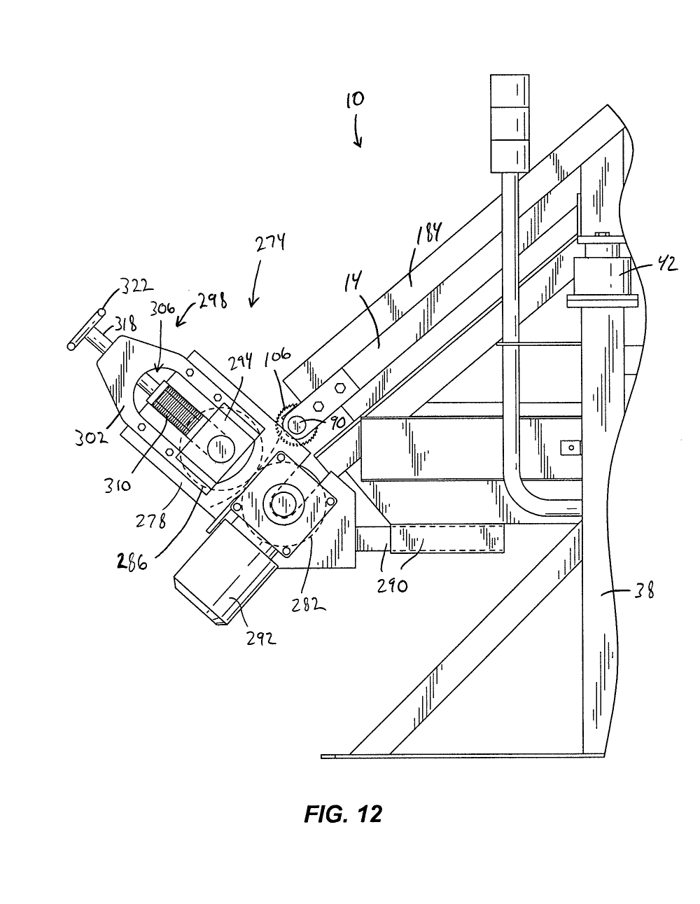

With reference to FIG. 12, a roller nip assembly 274 may be positioned adjacent the outlet of the vibrating screen 10 to further reduce the moisture content of the dewatered or de-liquefied slurry received from the vibrating screen 10 by applying a nip pressure to the slurry exiting the screen 18. The roller nip assembly 274 includes opposite end frames 278 (only one of which is shown), a first roller 282 extending between the respective end frames 278, and a second roller 286 extending between the respective end frames 278 and nipped or loaded against the first roller 282. Each of the rollers 282, 286 includes a rubber (e.g., nitrile) outer covering to provide a nip length of at least about 1 inch when nipped or loaded against each other. Although not shown in the drawings, a tray or pan may be utilized to support the slurry as it transitions from the screen 18 to the roller nip assembly 274.

Each of the respective end frames 278 is coupled to the frame 14 of the vibrating screen 10 by a telescoping support arm 290, which allows incremental positioning of the roller nip assembly 274 relative to the outlet of the vibrating screen 10. Alternatively, different structure may be utilized to support the roller nip assembly 274 relative to the outlet of the vibrating screen 10 at adjustable or fixed distances.

The roller nip assembly 274 also includes a motor 292 (e.g., an electric or hydraulic motor) and a gearbox (not shown) drivably coupled to at least one of the rollers 282, 286. In the illustrated construction of the roller nip assembly 274, the first or lower roller 282 is the drive roller, while the second or upper roller 286 is the driven roller. Alternatively, the motor and gearbox may be drivably coupled to the upper roller 286. The motor and gearbox are operable to drive the lower roller 282 between about 6 revolutions/minute and about 20 revolutions/minute. As both rollers 282, 286 include nominally the same diameter (e.g., between about 4 inches and about 6 inches), the upper driven roller 286 rotates at substantially the same speed as the lower drive roller 282.

With continued reference to FIG. 12, the position of the lower roller 282 relative to each of the end frames 278 is fixed, while the position of the upper roller 286 relative to each of the end frames 278 is not rigidly constrained. More particularly, a bearing block 294 supporting each end of the upper roller 286 is slidably coupled to the respective end frames 278 to facilitate sliding movement of the bearing blocks 294, and therefore the upper roller 286, relative to the end frames 278 in response to a varying thickness of slurry passing through the nipped rollers 282, 286. The roller nip assembly 274 further includes a nip pressure adjustment assembly 298 coupled to each of the end frames 278. Each of the nip pressure adjustment assemblies 298 includes a bracket 302 fixed to the end frames 278, an actuator 306 supported by the bracket 302, and a resiliently deflectable member (e.g., a spring 310) positioned between the actuator 306 and a perch on the bearing block 294.

In the illustrated construction of the roller nip assembly 274, the actuator 306 includes a threaded rod 318 threaded to the bracket 302 (e.g., using a nut joined to the bracket by welding, etc.). One end of the threaded rod 318 is engaged with the spring 310, while the other end of the threaded rod 318 includes a handle 322 to facilitate rotation of the threaded rod 318. To increase the nip pressure between the respective rollers 282, 286, an operator of the roller nip assembly 274 would increase the pre-load of the respective springs 310 by rotating the threaded rods 318 in a clockwise direction, provided the rods 318 include a right-handed thread. As a result, an increased amount of force is required to separate the respective rollers 282, 286 during operation of the roller nip assembly 274. Likewise, to decrease the nip pressure between the respective rollers 282, 286, an operator of the roller nip assembly 274 would decrease the preload of the respective springs 310 by rotating the threaded rods 318 in a counterclockwise direction. As a result, a decreased amount of force is required to separate the respective rollers 282, 286 during operation of the roller nip assembly 274. Alternatively, the actuator 306 may be configured as a linear actuator that is controllable by the controller 202 to provide the desired nip pressure between the rollers 282, 286.

When it is desired to use the roller nip assembly 274 with the vibrating screen 10, an operator of the vibrating screen 10 need only to mount the roller nip assembly 274 to the vibrating screen 10 using the telescoping support arms 290 and make an electrical connection between the roller nip assembly 274 and the controller 202 (e.g., an electrical connection with the motor 292 of the assembly 274; see FIG. 14). In this manner, the controller 202 is operable to automate operation of the roller nip assembly 274 in conjunction with the operation of the vibrating screen 10, including operation of each of the sub-systems of the vibrating screen 10 (e.g., operation of the vibration device 22, the clamping cylinders 186, the canopy cylinders 250, and the pressurized fluid spray assembly 118). As previously mentioned, a conveyor may also be positioned adjacent the outlet of the roller nip assembly 274 to carry away the de-watered slurry. The conveyor may be controlled by the controller 202 or may operate independently of the vibrating screen 10.

The vibrating screen 10 may also include in an inclination assembly (not shown) operable to allow real-time adjustment of the inclination angle of the screen 18 relative to the ground. In some constructions of the vibrating screen 10, the inclination assembly may adjust the inclination angle of the screen relative to the ground by as much as 20 degrees to about 60 degrees. The inclination assembly may include a frame or cradle having an arcuate outer periphery along which a plurality of rollers engage. The inclination assembly may be manually operated by the user of the vibrating screen 10 (e.g., by a system of hand cranks, etc.), or automatically operated by a control system. In combination with the inclination assembly, the previously-mentioned header 50 that transfers slurry from the tank 46 to the screen 18 may be adjusted in real time with the inclination angle of the screen 18 to provide an uninterrupted flow of slurry onto the screen 18.

As previously mentioned, a control system is used to fully automate the operation of the vibrating screen 10. In a first automated sequence, the controller 202 actuates the valves 270 to exhaust the pressurized air in the cylinders 250 to the atmosphere, thereby allowing the canopy 134 to pivot downwardly under its own weight. After the rods 258 of the cylinders 250 are fully retracted, the stop 266 triggers the limit switch 262 on each cylinder 250 which, in turn, signals the controller 202 that the canopy 134 is closed. Only after the controller 202 is signaled that the canopy 134 is closed will the controller 202 initiate a backwash cycle of the screen 18 using the pressurized fluid spray assembly 118. The controller 202 may be programmed with a predetermined schedule for operating the pressurized fluid spray apparatus 118, or the user of the vibrating screen 10 may manually operate the pressurized fluid spray apparatus 118.

After the controller 202 is signaled that the canopy 134 is closed, the controller then initiates operation of the motor 158 to reciprocate the conduit 122 along the tracks 154 and initiates the pump 350 to generate pressurized fluid for discharge through the conduit 122, and against the underside of the screen 18. The limit switches 342, 346 are tripped by the reciprocating movement of the conduit 122 and signal the controller 202 to reverse the motor 158 as previously described. After the backwash cycle or sequence is completed (e.g., after about three minutes), the controller 202 initiates a second automated sequence by stopping the motor 158 and the pump 350 (thereby stopping the discharge of pressurized fluid through the screen 18), and then opening the canopy 134. Specifically, the controller 202 actuates the valves 270 to direct pressurized air (from a source of pressurized air) into the lower part of the cylinders 250 to extend the rods 258 and open the canopy 134. The controller 202 may continue operating the vibration device 22 and the roller nip assembly 274 (and optionally the conveyor) during the backwash cycle or sequence. By fully automating operation of the vibrating screen 10 (and in particular, operation of the canopy 134 and the pressurized fluid spray assembly 118), the pressurized fluid spray assembly 18 may be utilized to flush any clogged pores in the screen 18 at predetermined, scheduled intervals to ensure efficient dewatering of the slurry as it moves along the screen 18, while between intervals of operation of the pressurized fluid spray assembly 18, the canopy 134 may be opened to allow the operator of the vibrating screen 10 to visually inspect the slurry moving along the length of the screen 18 to ensure sufficient dewatering of the slurry is achieved.

Various features of the invention are set forth in the following claims.

What is claimed is:

1. A vibrating screen comprising:
a frame;
a screen supported by the frame;
a vibration device coupled to the frame to vibrate the screen;
a pressurized fluid spray assembly operable to discharge a pressurized fluid against the screen;
a canopy coupled to the frame and movable between a closed position, in which at least a top side of the screen is covered by the canopy, and an open position, in which at least a portion of the top side of the screen is uncovered;
an actuator coupled between the frame and the canopy to move the canopy between the closed and open positions; and
a controller operably coupled to the actuator and the pressurized fluid spray assembly, wherein the controller is operable to close the canopy and initiate operation of the pressurized fluid spray assembly in an automated sequence.

2. The vibrating screen of claim 1, wherein the pressurized fluid spray assembly is positioned below the screen, and wherein the pressurized fluid is discharged through the screen.

3. The vibrating screen of claim 2, wherein at least some of the pressurized fluid discharged through the screen impacts the canopy and is redirected downwardly to the top side of the screen.

4. The vibrating screen of claim 1, wherein the automated sequence is a first automated sequence, and wherein the controller is operable to cease operation of the pressurized fluid spray assembly and open the canopy in a second automated sequence.

5. The vibrating screen of claim 1, wherein the pressurized fluid spray assembly includes
a conduit into which the pressurized fluid is delivered; and
a plurality of nozzles coupled to the conduit and in fluid communication with an interior of the conduit to receive pressurized fluid therefrom;
wherein the conduit is movable relative to the screen to spray pressurized fluid against the screen.

6. The vibrating screen of claim 5, wherein the pressurized fluid spray assembly further includes
an endless drive member supported for rotation relative to the frame, the conduit coupled to the endless drive member for co-rotation with the endless drive member; and
a motor coupled to the endless drive member to rotate the endless drive member and move the conduit along the screen.

7. The vibrating screen of claim 6, wherein the controller is operably coupled to the motor to selectively reverse the motor to reciprocate the conduit along the screen.

8. The vibrating screen of claim 1, further comprising:
a first clamping member disposed adjacent a first longitudinal edge of the screen; and
a second clamping member disposed adjacent a second longitudinal edge of the screen;
wherein each of the first and second clamping members is movable between a first position, in which the longitudinal edges of the screen are clamped against the frame, and a second position, in which the longitudinal edges of the screen are unclamped from the frame.

9. The vibrating screen of claim 8, further comprising:
a second actuator coupled between the first clamping member and the frame; and
a third actuator coupled between the second clamping member and the frame;
wherein the controller is operably coupled to the second and third actuators to move the first and second clamping members, respectively, between the first and second positions.

10. The vibrating screen of claim 1, wherein the canopy is pivotably coupled to the frame about an axis oriented transversely to a longitudinal axis of the screen.

11. The vibrating screen of claim 10, wherein the actuator is a first actuator coupled between the frame and a first side of the canopy parallel to the longitudinal axis of the screen, and wherein the vibrating screen further comprises a second actuator coupled between the frame and a second side of the canopy parallel to the longitudinal axis of the screen to pivot the canopy between the closed and open positions.

12. The vibrating screen of claim 1, wherein the actuator includes
a housing coupled to one of the frame and the canopy;
an extensible rod coupled to the other of the frame and the canopy; and
a limit switch in electrical communication with the controller and operable to provide a signal to the controller when the extensible rod is one of fully extended from the housing and fully retracted into the housing.

13. The vibrating screen of claim 1, further comprising a valve in electrical communication with the controller and in fluid communication with a source of pressurized fluid, wherein the controller is operable to actuate the valve to fluidly communicate the actuator with the source of pressurized fluid to fill the actuator with pressurized fluid to move the canopy from the closed position to the open position.

14. The vibrating screen of claim 13, wherein the controller is operable to actuate the valve to fluidly communicate the actuator with the atmosphere to release the pressurized fluid from the actuator to move the canopy from the open position to the closed position.

15. The vibrating screen of claim 1, further comprising a plurality of flow separators disposed over the top side of the screen.

16. The vibrating screen of claim 1, further comprising:
a first support member attached to a first end of the screen and supported by the frame; and
a second support member attached to a second end of the screen and rotatably supported by the frame;
wherein the second support member is rotated relative to the frame to tighten the screen over the frame.

17. The vibrating screen of claim 16, further comprising a locking mechanism operable to prevent rotation of the second support member relative to the frame.

18. The vibrating screen of claim 17, wherein the locking mechanism includes a ratchet wheel coupled to the second support member and a pawl pivotably coupled to the frame to allow rotation of the second support member relative to the frame in a first direction, and to prevent rotation of the second support member relative to the frame in a second direction.

19. The vibrating screen of claim 1, further comprising a roller nip assembly supported by the frame and disposed adjacent an outlet end of the screen.

20. The vibrating screen of claim 19, wherein the roller nip assembly includes a first roller;
a second roller nipped against the first roller; and
a motor drivably coupled to the second roller and operably coupled to the controller.
